(19) United States
(12) Patent Application Publication
(10) Pub. No.: US 2016/0231789 A1
(43) Pub. Date: Aug. 11, 2016

(54) TABLET COMPUTER ACCESSORY BAR

(71) Applicant: Hewlett-Packard Development Company, L.P., Houston, TX (US)

(72) Inventors: Aki LAINE, Houston, TX (US); Dimitre D. MEHANDJIYSKY, Houston, TX (US); Michael J. DELPIER, Houston, TX (US)

(21) Appl. No.: 15/021,584

(22) PCT Filed: Oct. 31, 2013
(86) PCT No.: PCT/US2013/067899

§ 371 Date: Mar. 11, 2016

(51) Int. Cl. G06F 1/16; H04R 3/12; H04R 1/02

(52) U.S. Cl. CPC G06F 1/1688; G06F 1/1635; H04R 1/026; H04R 3/12; H04R 2499/15

(57) ABSTRACT

A tablet computer accessory bar is for use with a tablet computer having a tablet edge, The accessory bar comprises an accessory edge to face and abut the tablet edge. The accessory bar further comprises a hook and a release actuator. The hook is receivable within an opening in the tablet edge and movable between a tablet computer connected state and a tablet computer disconnected state. The release actuator is operably coupled to the hook to be manually engaged to move the hook to the tablet computer disconnected state.

### BACKGROUND

As compared to laptop computers and desktop computers, tablet computers are compact and lightweight. However, due to their compact nature, tablet computers lack many features or capabilities available in laptop and desktop computers.

### BRIEF DESCRIPTION OF THE DRAWINGS

FIG. 1 is a schematic illustration of an example expanded tablet computer system comprising a tablet computer accessory bar for use with a tablet computer.

FIG. 2 is a schematic illustration of the example expanded tablet computer system of FIG. 1 with the tablet computer accessory bar connected to the tablet computer.

FIG. 2A is a side elevational view of the example expanded tablet computer system of FIG. 2.

FIG. 3 is a schematic illustration of another implementation of the tablet computer accessory bar of FIG. 1.

FIG. 4 is a schematic illustration of another implementation of the expanded tablet computer system of FIG. 1.

FIG. 5 is a side elevational view of the example expanded tablet computer system of FIG. 4.

FIG. 6 is a flow diagram of an example method that may be carried out by the expanded tablet computer system of FIG. 4.

FIG. 7 is a flow diagram of another example method that may be carried out with the expanded tablet computer system of FIG. 4.

FIG. 8 is a perspective view of an example implementation of the expanded tablet computer system of FIG. 4, illustrating a tablet computer accessory bar disconnected from the tablet computer.

FIG. 9 is a front elevational view of the example expanded tablet computer system of FIG. 8 illustrating the tablet computer accessory bar connected to the tablet computer.

### DETAILED DESCRIPTION OF THE EXAMPLE EMBODIMENTS

FIG. 1 schematically illustrates an example tablet computer accessory bar 20 for use with a tablet computer 22 having a tablet edge 24 and a hook receiving opening 26 along tablet edge 24. Tablet computer accessory bar 20 provides additional accessory features or functions 28 for tablet computer 22. Examples of different accessory functions that may be provided by tablet computer accessory bar 20 comprise a supplemental or alternative speaker, an alternative or additional battery, a memory card slot, and accessory communication port and a suspension anchor for connection to a suspension line such as a lanyard, a shoulder or band strap and the like.

Accessory bar 20 mates with tablet edge 24. FIGS. 2 and 2A illustrate accessory bar 20 connected to tablet computer 22. As shown by the example illustrated in FIG. 2A, accessory bar 20 comprises a top face 30 and a bottom face 32. Top face 30 is parallel to top face 34 and display panel 35 of tablet computer 22 when accessory bar 20 is connected to tablet computer 22. Bottom face 32 is parallel to and coplanar with bottom face 36 of tablet computer 22 when accessory bar 20 is connected to tablet computer 22. Because bottom face 32 is parallel to and coplanar with bottom face 36 of tablet computer 22, accessory bar 20 when connected a tablet computer 22 forms a continuous bottom support surface that is level, allowing the expanded tablet computer system 40 formed by accessory bar 20 and tablet computer 22 to horizontally rest upon a flat underlying surface with minimal rocking.

As shown by FIGS. 2 and 2A, in the example illustrated, accessory bar 20 has side accessory edges 42 which are parallel to and contiguous with side tablet edges 44 of tablet computer 22. In the example illustrated, top face 30 of accessory bar 20 is also contiguous with top face 34 of tablet computer 22. As a result, accessory bar 20 matches a thickness and a width of tablet computer 22 to avoid or minimize outwardly projecting edges, shoulders avoids surfaces which might otherwise catch upon other objects when tablet computer 22 is being transported or stored. In addition, the expanded tablet computer system 40 formed by the combination of accessory bar 20 and tablet computer 22 is sleek and more closely resembles a single integral unit. In other implementations, accessory bar 20 may be narrower than tablet computer 22 or wider than tablet 22. In other implementations, top face 30 is recessed below or projects above top face 34 of tablet computer 22. Although illustrated as being connected to tablet computer 22 along the shorter side edge of tablet computer 22, in other implementations, accessory bar 20 is alternatively connected to a longer side edge of tablet computer 22.

As shown by FIGS. 1 and 2, tablet computer accessory bar 20 is configured to be releasably connected to tablet computer 22 utilizing connector 50. In the example illustrated, connector 50 comprises a movable hook 52 and release actuator 54. Hook 52 extends from accessory bar edge or accessory edge 56 of connector bar 20 so as to be receivable within opening 26 of tablet computer 22 when accessory bar 20 is connected to tablet computer 22. In the example illustrated, hook 52 is insertable into opening 26 and is movable in directions indicated by arrows 58 while within opening 26, parallel to edge 56, for movement between as disconnected state in which hook 52 is withdrawn from an internal catch shoulder surface 60 within opening 26 and a computer connected state in which hook 52 engages the internal catch shoulder surface 60 within opening 26.

Release actuator 54 comprises a mechanism operably coupled to hook 52 and located to be manually engaged or manually contacted to move hook 52 between the disconnected state and the connected state. In one implementation, hook 52 is resiliently biased towards the connected state (shown in broken lines), wherein release actuator 54 moves hook 52 against the bias towards the disconnected state. In one implementation, release actuator 54 comprises a sliding bar operably coupled to hook 52 to move hook 52 against the resilient bias (such as provided by spring) from the connecting position or state to the disconnected position or state.

In other implementations, release actuator 54 may comprise a pushbutton and a mechanical transmission operably coupling release actuator 54 to hook 52. In yet other implementations, release actuator 54 may comprise as switch, button or other input by which a powered actuator, such as a solenoid, maybe actuated to move hook 52 between the connected and disconnected positions or states. When in the disconnected position or state, hook 52 is insertable into mouth 62 of tablet computer 22. Release of release actuator 54 allows hook 52 to resiliently return to the connecting position or state (shown broken lines) while within opening 26 so as to engage surface 60 to releasably retain accessory bar 20 to tablet computer 22. Although accessory bar 20 is illustrated as comprising a single connector 50 or a single hook 52 actuated by release actuator 54, in other implementations, accessory bar 20 may include multiple connectors 50 or multiple hooks 52 actuated by a single release actuator 54, wherein tablet computer 22 has a corresponding number of openings 26 corresponding to such hooks 52.

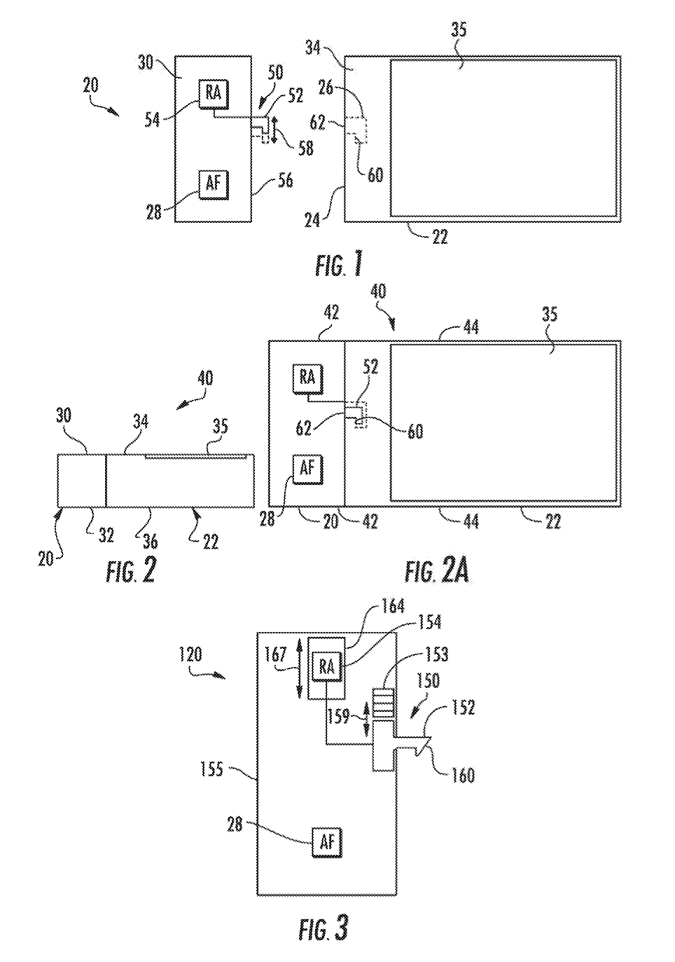

FIG. 3 schematically illustrates accessory bar 120, an example implementation of accessory bar 20. Accessory bar 120 is similar to accessory bar 20 except that accessory bar 120 is illustrated as specifically including connector 150, an example implementation of connector 50. Connector 150 comprises hook 152, bias 153 and release actuator 154.

Hook 152 is movably supported and guided relative to the body 155 of accessory bar 120 in the direction indicated by arrows 159 by one or more internal grooves, tracks, bearings or the like. Hook 152 is movable between a tablet computer connecting or retention position and a disconnected or insertion/releasing position. Hook 152 projects from body 155 and is shaped and sized for reception within opening 26 (illustrated in FIG. 1) or a similarly configured opening. In the example illustrated, hook 152 comprises a ramped, inclined, angled or sloped cam surface 160 which may be positioned in contact with an edge of opening 26 to interact with tablet computer 22 to move hook 152 against bias 153 toward the disconnected position, facilitating insertion of hook 152 into opening 26 (shown in FIG. 1) and subsequent return to a connected state under the force of bias 153. In other implementations, surface 160 may have other shapes.

Bias 153 resiliently biases hook 152 towards the connected position or state in which hook 152 engages a catching surface 60 within aperture 26. In the example illustrated, bias 153 comprises a compression spring captured between an internal surface of body 155 and hook 152, wherein movement of hook 152 towards a disconnected state compresses the compression spring serving as bias 153. In other implementations, bias 153 may comprise a tension spring which is stretched as hook 152 moves from the connected state towards the disconnected state. In yet other implementations, instead of hook 152 being linearly movable between the connected state and the disconnected state, hook 152 may be rotatable between a connected state and a disconnected state or rotatable between a retracted position and an extended position. In such an implementation, hook 152 is resiliently biased to the extended or connected state by a torsion spring captured between an internal structure of body 155 and hook 152.

Release actuator 154 comprises a manually engageable or manually contactable structure operably coupled to hook 152 to move hook 152 against bias 153 from a connecting state to a disconnected or insertion/releasing state. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members.

In the example illustrated, release actuator 154 comprises a bar slidable or linearly movable within an elongate channel 164 in the direction indicated by arrows 167. The sliding bar serving as release actuator 154 is operably coupled to hook 152 by one or more force transmitting structures serving as a transmission. As noted above, in other implementations, release actuator 154 may alternatively comprise a dial rotatable so as to rotate hook 152 against the bias 153 between a tablet computer connecting and retaining state and a disconnected, release/insertion state.

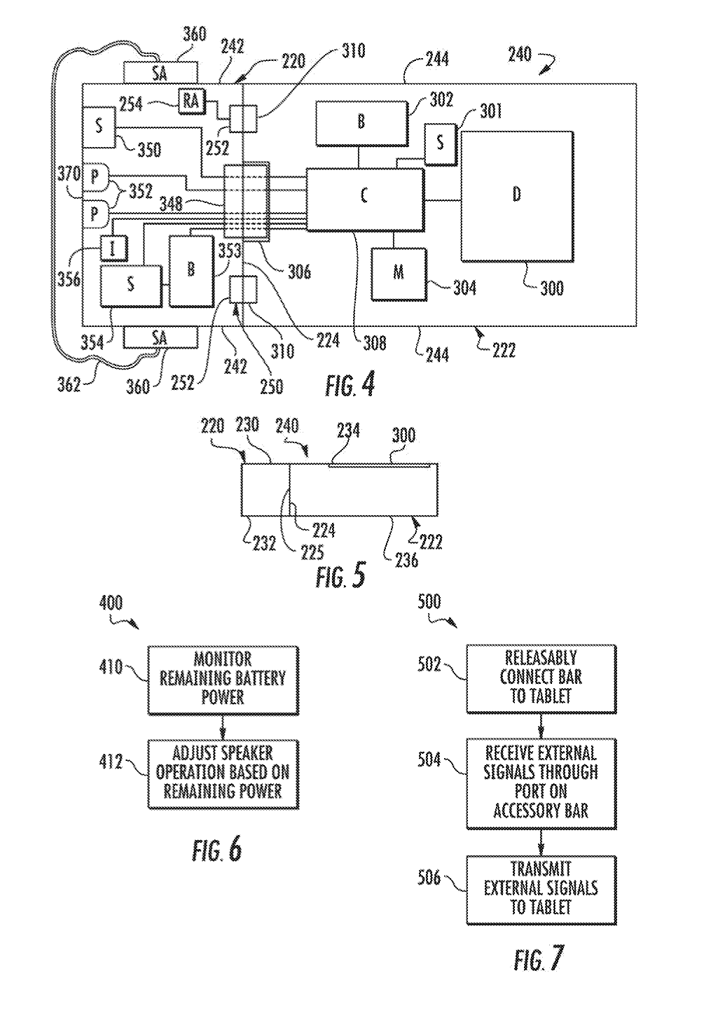

FIG. 4 schematically illustrates expanded tablet computer system 240 formed by accessory bar 220 and tablet computer 222. Tablet computer 222 comprises display 300, speaker 301, battery 302, memory 304, communication port 306, controller 308 and connector interfaces 310. Display 300 comprises a display panel or display screen by which video, graphics and the like may be visibly presented to a user. In one implementation display 300 covers substantially in entirety of a top or upper surface of tablet computer 222. In one implementation, display 300 comprises a touch screen, facilitating input of commands, selections and data. Speaker 301 receives audio signals from controller 308 and amplifies such audible signals.

Battery 302 comprises a rechargeable battery internally housed within tablet computer 222 for powering tablet computer 222. In some implementations, battery 302 may additionally power components of accessory bar 220. In one implementation, battery 302 comprises a rechargeable lithium ion battery. In another implementation, battery 302 may comprise other types of batteries.

Memory 304 comprises a non-transitory computer readable medium which stores data, instructions for the control of tablet computer 222 and executable applications or programs for tablet computer 222. In one implementation, memory 304 further stores executable instructions for the operation of one or more components of accessory bar 220. In one implementation, memory 344 may comprise a random access memory (RAM) for execution by the processing unit from a read only memory (ROM), a mass storage device, or some other persistent storage. In one implementation, memory 304 comprises an integrated circuit or flash memory. In one implementation, memory 304 is built into the housing of tablet computer 222. In yet another implementation, memory 304 or portions of memory 304 comprises a removal memory card received within a memory card slot or the like in tablet computer 222.

Communication port 306 comprises a port by which electronic signals representing data or instructions are transmitted between tablet computer 222 and accessory bar 220. In some implementations, power is also transmitted through communication port 306 to or from accessory bar 220. Because communication port 306 comprises a female receptacle for receiving corresponding communications plug extending from accessory bar 220, communication port 306 is less conspicuous and is less likely to catch up on external objects when tablet computer 222 is disconnected from and used independent of accessory bar 220.

Controller 308 comprises one or more processing units to carry out instructions stored in memory 304 to direct the display of graphs and data using display 300 as well as provide sound through one or both of speakers 301 and through supplemental speakers provided in accessory bar 220. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device or some other persistent storage. In other embodiments, hard wired circuitry may be used in place of or in combination with software instructions to implement the functions described. For example, controller 308 may be embodied as part of one or more application-specific integrated circuits (ASICs). Unless otherwise specifically noted, the controller is not limited to any specific combination of hardware circuitry and software, nor to any particular source for the instructions executed by the processing unit. In addition to controlling the operation of tablet computer 222, controller 308 receives additional inputs and is capable of accessing additional memory provided by accessory bar 220.

Connector interfaces 310 comprise structures extending along edge 224 and configured to interact with corresponding connector interfaces or portions of accessory bar 220 so as to releasably retain and secure accessory bar 220 to and along edge 224 of tablet computer 222. In the example illustrated, connector interfaces 310 are located on opposite sides of communication port 306 for releasable interconnection of accessory bar 220 and tablet computer 222. In other implementations, tablet computer 222 may include a single connector interface 310 or greater than two connector interfaces 310. In one implementation, connector interface 310 comprises an opening and catch surface such as opening 26 and surface 60 described above with respect to tablet computer 22.

Accessory bar 220 releasably connects to tablet computer 22 and includes multiple auxiliary or accessory features/functions. Accessory bar comprises connector 250, communication/power interface 348, memory card slot 350, communication ports 352, battery 353, speaker 354, input 356, suspension anchors 360 and suspension 362. Connector 250 connects accessory bar 220 to tablet computer 222. As shown by FIG. 5, accessory bar 220 mates with edge 224 of tablet computer 222 to form expanded tablet computer system 240. Accessory bar comprises a top face 230 and a bottom face 232. Top face 230 is parallel to top face 234 and display panel 300 of tablet computer 222 when edge 225 of accessory bar 220 is positioned in abutment with edge 224 and connected to tablet computer 222. Bottom face 232 is parallel to and coplanar with bottom face 236 of tablet computer 22 when accessory bar 220 is connected to tablet computer 222. Because bottom face 232 is parallel to and coplanar with bottom face 236 of tablet computer 222, accessory bar 220 when connected a tablet computer 222 forms a bottom support surface that is level and substantially flat, allowing the expanded tablet computer system 240 formed by accessory bar 220 and tablet computer 222 to horizontally rest upon a flat underlying surface with minimal rocking.

As shown by FIG. 4, in the example illustrated, accessory bar 220 has side edges 242 which are parallel to and contiguous with side edges 244 of tablet computer 222. In the example illustrated, top face 230 of accessory bar 220 is also contiguous with top face 234 of tablet computer 22. As a result, accessory bar 220 matches a thickness and a width of tablet computer 222 to avoid or minimize outwardly projecting edges, shoulders avoids surfaces which might otherwise catch upon other objects when tablet computer 222 is being transported or stored. In addition, the expanded tablet computer system 240 formed by the combination of accessory bar 220 and tablet computer 222 is sleek and more closely resembles a single integral unit. In other implementations, accessory bar 220 may be narrower than tablet computer 222 or wider than tablet 222. In other implementations, top lace 230 is recessed below or projects above top face 234 of tablet computer 222. Although illustrated as being connected to tablet computer 222 alone the shorter side of tablet computer 222, in other implementations, accessory bar 220 is alternatively connected to a longer side of tablet computer 222.

In the example illustrated, connector 250 is similar to connector 150 shown in FIG. 3 except that connector 250 comprises a pair of hooks 252 (schematically shown), each of hooks 252 being operably coupled to a single release actuator 254. Each of hooks 252 is resiliently biased by a spring 153 (shown FIG. 3) towards a tablet computer connected state or position and is movable against the bias of spring 153 towards a disconnected, insertion/release position or state in response to engagement of release actuator 254. Each of hooks 252 extends from edge 225 of connector bar 220 so as to be receivable within openings provided by connector interfaces 310 of tablet computer 222 when accessory bar 220 is connected to tablet computer 222.

Communication/power interface 348 comprises a structure which interfaces with tablet computer 222 to facilitate the transmission of data/control signals and power between accessory bar 220 and tablet computer 222. In the example illustrated, interface 348 comprises a plug for ejecting from edge 225 of accessory bar 220 which is receivable within communication port 306 of tablet computer 222. Data signal and power transmission lines pass through interface 348. In one implementation, such data/control signals are transmitted in a wired fashion. In another implementation, data/control signals are transmitted in a wireless fashion, such as via optical signals or radiofrequency signals, from accessory bar 242 to an interconnected tablet computer 222.

Memory card slot 350 comprises a slot to receive a flash memory card. Memory card slot 350 is located within and along edge 370 of accessory bar 220 opposite to edge 225. As schematically illustrated memory card slat 350 is connected through interface 348 to controller 308 of tablet computer 222. As a result, controller 308 of tablet computer 222 is able to access contents of a memory card inserted within memory card slot 350, expanding the memory capabilities of tablet computer 222.

Communication ports 352 comprise female receptacles or openings along edge 370 facing away from edge 225 of accessory bar 220. In one implementation, communication ports 352 may comprise universal serial bus (USB ports) or other input/output ports. As schematically illustrated, communication ports 352 are connected through interface 348 to controller 308 of tablet computer 222. As a result, other devices may be connected to tablet computer 222 using the different types of communication ports 352 provided along edge 370 of accessory bar 220. Although accessory bar 220 is illustrated as comprising two ports 352, in other implementations accessory bar 220 may include additional or fewer of such communication ports 352.

Battery 353 comprises a battery carried by accessory bar 220. In one implementation, batting 353 is rechargeable. In one implementation, battery 353 comprises a lithium-ion battery. In yet other implementations, battery 353 may comprise other forms of rechargeable batteries. Battery 353 is connected to tablet 222 through power transmitting lines extending across interface 348. Battery 353 powers speaker 354 and further supplies auxiliary power to tablet computer 222.

Speaker 354 is housed within accessory bar 242 and is connected to controller 308 through interface 348 so as to receive audio signals from controller 308 of tablet computer 222 and so as to amplify audio signals from tablet computer 222. Speaker 354 cooperates with speaker 301 provide improved sound as compared to sound emanating from just speaker 301 alone.

Input 356 comprises input device carried by accessory bar 220 facilitating input of data, instructions, commands or selections. In one implementation, input 356 comprises a toggle bar, switch or pushbutton. In the example illustrated, input 356 is used by a user to instruct controller 308 to turn speaker 354 on when enhanced sound is desired or alternatively off when battery power is to be conserved. In another implementation, input 356 is directly connected to speaker 354 so as to turn speaker 354 on an off. In some implementations, input 356 may be omitted.

In one implementation, controller 308, following instructions contained in memory 304, automatically controls the operation of speaker 354 based upon power levels of battery 302 and battery 353. For example, in one implementation, controller 308 carries out method 400 set forth in FIG. 6. As indicated by step 410 in FIG. 6, controller 308 monitors power levels of battery 302 and 353. As indicated by step 412, based upon remaining power within battery 302 and 353, controller 308 automatically turns off speaker 354 when such better levels fall below a predefined threshold. In another implementation, controller 308 may automatically disable speaker 354 or cut off power to speaker 354 when battery levels within battery 353 fall below a predefined threshold. In yet another implementation, controller 308 displays prompts and allows a user to operate speaker 354 in one of two modes: a first mode in which speaker 354 draws power from battery 358 as well as battery 302 and a second mode in which speaker 354 is limited to drawing power from battery 358 such that speaker 354 does riot drain power from tablet computer 222. In other implementations, such control of speaker 354 may carried out in response to control signals generated by a separate processing unit carried by accessory bar 220.

Suspension anchors 360 comprise structures carried by accessory bar 220, wherein such structures are located, sized and shaped to connect to and support. suspension 362. In the example illustrated, suspension anchors 360 comprise ears on opposite side edges of accessory bar 220, such ears having portions to which suspension 362 may be connected. In one implementation, anchors 360 may comprise eyelets, rings or other structures through which suspension 362 may be tied or anchored. Suspension 362 comprises a strap, lanyard, or other structure extending from suspension anchors 360. In one implementation, suspension 362 has a length to suspend the combined extended tablet computer system 240 from a person's neck or shoulder. In another implementation, suspension 362 allows the expanded tablet computer system 242 be manually carried.

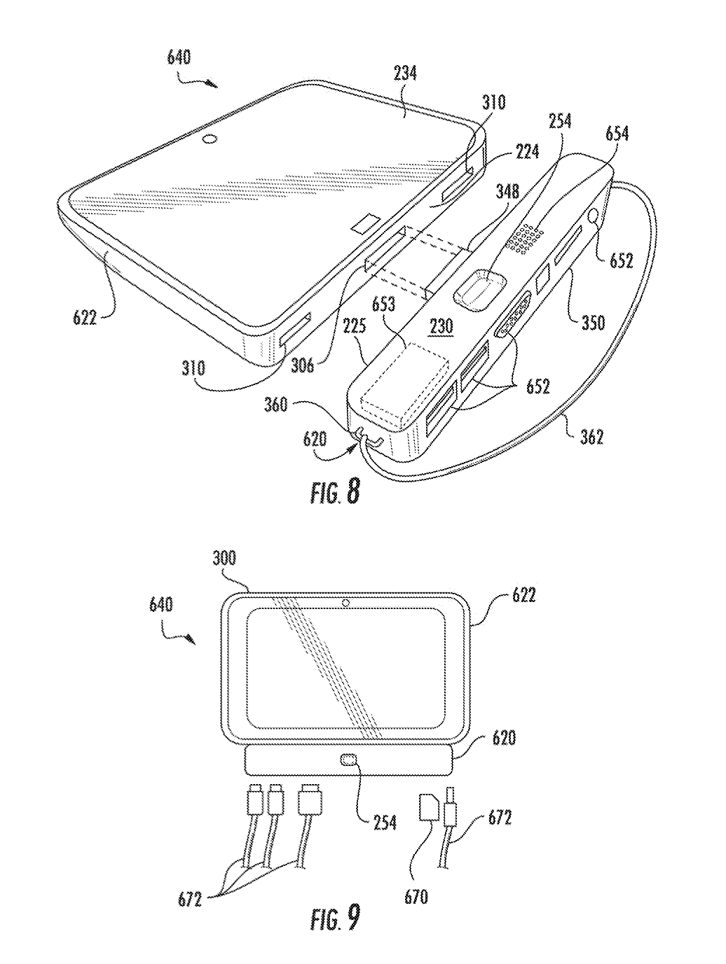

FIG. 7 is a flow diagram illustrating an example method 500 that may he carried out by the expanded tablet computer system 240 with accessory bar 220. As indicated by step 502, accessory bar 220 is releasably connected to tablet computer 222. In one of limitation, releasable connection of accessory bar 222 tablet computer 222 is achieved by engaging release actuator 254 to move the hooks 252 into insertion position, inserting such hooks 252 into apertures of interfaces 310 and then releasing the release actuator 254 such that hooks 252 are resiliently moved to a connected state, securing accessory bar 220 to tablet computer 222.

As indicated by step 504, accessory bar 220 receives external signals through communication ports 352. As indicated by step 506, such external signals received by communication ports 352 are transmitted to tablet computer 222 across communication interlace 348. As a result, accessory bar 220 provides tablet computer 222 with a larger array of different types of communication ports 352, increasing the versatility of tablet computer 222.

FIGS. 8 and 9 illustrate expanded tablet computer system 640, an example implementation of expanded tablet computer system 240. Expanded tablet computer system 640 comprises tablet computer accessory bar 620 and tablet computer 622. FIG. 8 illustrates accessory bar 620 connected to suspension 362 while being separated or disconnected from tablet computer 622. FIG. 9 illustrates accessory bar 620 connected to tablet computer 622 without suspension 362. Tablet computer 622 is similar to tablet computer 222 described above.

Tablet computer accessory bar 620 is similar to accessory bar 220 except that tablet computer accessory bar 620 is illustrated as specifically comprising communication ports 652 in lieu of communication ports 352. Those remaining components of expanded tablet computer system 640 which correspond to components of expanded tablet computer system 240 are numbered similarly. Tablet computer accessory bar 620 is releasably mountable to tablet computer 622 and provides tablet computer 622 with an additional memory slot 354 receiving a memory card 670 and a multitude of additional communication ports 652 (shown in FIG. 8) that allow a larger array of communication input/output lines 672 with different connector styles. As with accessory bar 220, accessory bar 620 also provides auxiliary or supplemental battery power with battery 653 and supplemental speakers 654. In other implementations, tablet computer accessory bar 620 may alternatively omit one or more of the above-described accessory features or functions. For example, in other implementations, accessory bar 620 may omit suspension anchors 360, may omit speaker 654, may omit memory slot 350, may omit one or more of communication ports 652 or may omit battery 653.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a tablet computer accessory bar for use with a tablet computer having a tablet edge, the accessory bar comprising:
an accessory edge to fare and abut the tablet edge;
a hook receivable within an opening in the tablet edge and movable between a tablet computer connected state and a tablet computer disconnected state; and
a release actuator operably coupled to the hook to be manually engaged to a move the hook to the tablet computer disconnected state.

2. The apparatus of claim 1, wherein the accessory bar further comprises an accessory speaker to amplifying audio signals from the tablet computer.

3. The apparatus of claim 2 further comprising a manual input to selectively activate and deactivate the speaker

4. The apparatus of claim 2 further comprising the tablet computer, wherein the tablet computer comprises:
a tablet computer speaker; and
accessory bar controller to selectively transmit audio signals from the tablet computer to one of the accessory speaker and the tablet computer speaker.

5. The apparatus of claim 1, wherein the accessory bar comprise accessory battery to supply power to the tablet computer.

6. The apparatus of claim 5, wherein the tablet computer comprises a tablet computer battery, wherein accessory bar comprises an accessory speaker and wherein the accessory speaker is operable while being disconnected from the tablet computer battery.

7. The apparatus of claim 1, wherein the accessory bar comprises a second accessory edge opposite the accessory edge, the second accessory edge comprising accessory communication ports for the tablet computer.

8. The apparatus of claim 1, wherein the accessory bar comprises a second accessory edge opposite the accessory edge, the second accessory edge comprising a memory card slot.

9. The apparatus of claim 1, the accessory bar comprises a suspension anchor to connect to a suspension line.

10. The apparatus of claim 1, wherein the accessory bar comprises:
a top face to be parallel to a top face of the tablet computer when the accessory bar is connected to the tablet computer; and
a bottom face to be parallel to and coplanar with the bottom face of the tablet computer when the accessory bar is connected to the tablet computer.

11. The apparatus of claim 1, the accessory bar further comprising:
a second accessory edge opposite the accessory edge, the second accessory edge comprising accessory communication ports for the tablet computer; and
an accessory speaker to amplifying audio signals from the tablet computer.

12. A tablet computer accessory bar comprising:
an outer housing;
a connector to releasably connect the outer housing to a tablet edge of a tablet computer;
a an accessory edge facing away from the tablet edge, the accessory edge a comprising an accessory communication port to communicate with the tablet computer.

13. The tablet computer accessory bar of claim 12 further comprising an accessory speaker carried by the outer housing to amplify audio signals received from the tablet computer.

14. A method comprising:
releasably connecting an accessory bar to a tablet computer;
receiving external signals through the communication port on the accessory bar and transmitting the external signals to the tablet computer.

15. The method of claim 14 further comprising receiving audio signals from the tablet computer and amplifying audio signals with a speaker on the accessory bar.
